(19) United States
(12) Patent Application Publication
(10) Pub. No.: US 2008/0007501 A1
(43) Pub. Date: Jan. 10, 2008

(54) Display system

(76) Inventors: Arnold W. Larson, Corvallis, OR (US); Stan E. Leigh, Corvallis, OR (US); William J. Allen, Corvallis, OR (US); Richard Aufranc, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/484,545

(22) Filed: Jul. 10, 2006

(51) Int. Cl. G09G 3/34

(52) U.S. Cl. 345/84

(57) ABSTRACT

One embodiment of a display system includes a rotational actuator that defines a rotational axis, an image shifter mounted on the rotational actuator for rotation about the rotational axis, the image shifter including an image shifting surface positioned non-perpendicular to the rotational axis, and a light modulator that projects a modulated image to the image shifting surface.

Display systems may display an image having the same resolution as an image input to the display system. In order to enhance a resolution of the displayed image, the input image may be shifted between several orthogonal positions by a plurality of orthogonally positioned actuators. Such systems may require a drive circuit for each actuator, may produce acoustic disturbance, and may include actuators that are flexibly mounted such that the displayed image is subject to external disturbances. It may be desirable to provide a display system that produces a displayed image having a resolution greater than a resolution of an input image, that may be operated without requiring expensive drive circuits and without producing acoustic disturbance, while reducing the effects of external disturbances on the displayed image.

### BRIEF DESCRIPTION OF THE DRAWINGS

FIG. 1 represents a schematic view of a display system according to one embodiment of the present invention and including a reflective image shifting surface.

FIG. 2 represents a schematic front view of a pixel of the image shifting surface in several different positions.

FIG. 3 represents a schematic view of the display system of FIG. 1 wherein the image shifting surface is rotated 180 degrees from the position shown in FIG. 1.

FIG. 4 represents a schematic view of a display system according to another embodiment of the present invention and including a transmissive image shifting surface.

FIG. 5 represents a schematic view of the display system of FIG. 4 wherein the image shifting surface is rotated 180 degrees from the position shown in FIG. 4.

### DETAILED DESCRIPTION OF THE DRAWINGS

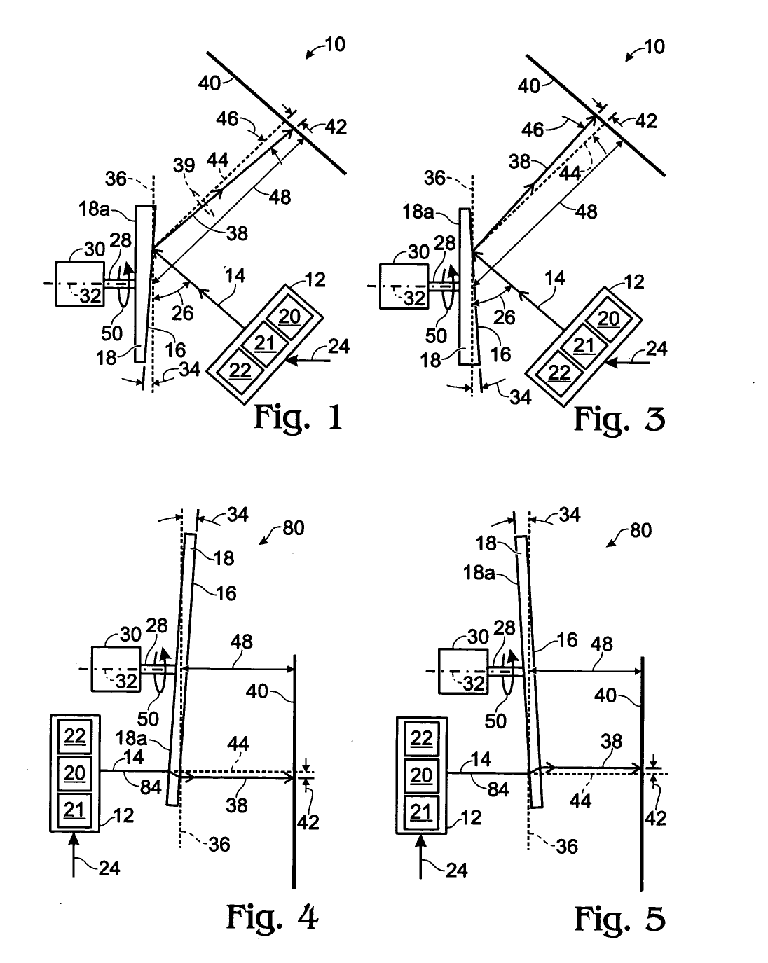

FIG. 1 represents a schematic view of a display system 10 according to one embodiment of the present invention. Display system 10 may include a controller 12 that projects an input light image 14 to an image shifting surface 16 of an image shifter 18. In the embodiment shown in FIG. 1, image shifter 18 may be a reflective image shifter such that image shifting surface 16 may be a mirror or other reflective surface. Image shifting surface 16 may define a plurality of pixels, such as an array of 1,024 by 786 pixels to create a final image. The plurality of pixels are typically defined by controller 12 and, specifically, by the light modulator 21. Image shifting surface 16 preserves the image information encoded in input light image 14.

Controller 12 may include a light source 20, a light modulator 21, and computer operable instructions 22 that receive input data 24 and convert the input data 24 into input light image 14. Modulator 21 may provide a modulated image by turning light on and off, wherein the image subframes may be synchronized to the rotational position of image shifter 18. Image subframes are described in detail in U.S. Pat. No. 7,030,894, entitled IMAGE DISPLAY SYSTEM AND METHOD, issued on Apr. 18, 2006, and hereby incorporated by reference in its entirety herein. Modulator 21 may be a light modulator as described in U.S. Pat. No. 7,030,894 B2, entitled IMAGE DISPLAY SYSTEM AND METHOD, issued on Apr. 18, 2006, and hereby incorporated by reference in its entirety herein. Input image 14 may comprise a single image from an electronic video data stream including a continuous stream of input images. Input light image 14 may be positioned at an angle 26 with respect to a plane 36 in a range of five to eighty five degrees, for example. In the embodiment shown in FIG. 1, angle 26 is approximately forty five degrees. Light source 20 may be any light source sufficient for a particular application, such as a light bulb, a laser, or the like. In one embodiment, angle 26 is measured between the path of input image 14 and to plane 36, rather than to image shifting surface 16 because the position of image shifting surface 16 may change as it rotates and because the difference in position between plane 36 and image shifting surface 16 may be only a few degrees.

Image shifter 18 may be mounted on a shaft, such as a rigid shaft 28, connected to an actuator, such as a motor 30, wherein motor 30 rotates shaft 28 about a rotational axis 32 extending along shaft 28. Due to the rigid nature of shaft 28, external disturbances may not appreciably affect an image 38 output by display system 10. Motor 30 may be a dc motor, a stepper motor, or any other device operable to rotate shaft 28 about axis 32. Motor 30 may rotate shaft 28 and image shifter 18 continuously or between predetermined stop positions wherein the image shifter 18 remains at the stop position for a predetermined dwell time. Rotation of motor 30 in a continuous or step wise fashion may utilize reduced drive circuitry, thereby decreasing the cost of the display system of the present invention, when compared to systems of the prior art. Moreover, due to the rotational nature of the actuator or motor 30 utilized in the present invention, motor 30 may have a relatively small noise output when compared to back and forth reciprocating actuators of the prior art.

Image shifter 18 is mounted on shaft 28 such that image shifting surface 16 of image shifter 18 is positioned at an angle 34 with respect to a plane 36 positioned perpendicular to rotational axis 32. In one embodiment, angle 34 of image shifting surface 16 may be parallel to a back surface 18a of image shifter 18, wherein the entire image shifter is mounted at an angle 34, with respect to plane 36, on shaft 28. In another embodiment, angle 34 of image shifting surface 16 may be positioned at an angle 34 with respect to back surface 18a of image shifter 18 such that back surface 18a of image shifter 18 is mounted on shaft 28 perpendicular to rotational axis 32 and parallel to plane 36. Other embodiments may also be utilized to position image shifting surface 16 at desired angle 34 with respect to plane 36 and rotational axis 32.

Angle 34 may be chosen to result in an output image 38 received on an image plane 40 from image shifting surface 16 that is deflected a predetermined distance 42 from an undeflected light path 44. Predetermined distance 42 may be related to an angle 46, measured between undeflected light path 44 and the path of output image 38. Angle 46 generally may be equal to two times angle 34 of image shifting surface 16 with respect to plane 36. Mathematically, distance of deflection 42 (D) may be equal to two times angle 34 (theta 1) times the distance 48 (L) from image shifting surface 16 to image plane 40, times a constant (K) (which is equal to 1.0 when there is no projection lens), times the cosine of an angle of rotation 50 (theta 2) of image shifter 18 about rotational axis 32, as represented by the equation:

D=2 (theta 1)LK cos(theta 2) Equation 1

In the embodiment shown, distance 48 is shown extending from image plane 40 to plane 36 at a position on image shifter 18 aligned with rotational axis 32, in contrast to other locations along plane 36 or along image shifting surface 16 which may be chosen in other embodiments. Measurement of distance 48 at this position on plane 36 yields accurate data from Equation 1 because distance 48 is generally much greater than the width of surface 16 as measured in plane 36. In one embodiment, distance 48 may be several feet whereas the width of surface 16, as viewed in FIG. 1, may be a portion of an inch. In other words, distance 48 may be measured from any point along plane 36 (or from any point on image shifting surface 16 of image shifter 18), because distance 48 is much greater than the width dimension of image shifter 18 as measure in plane 36.

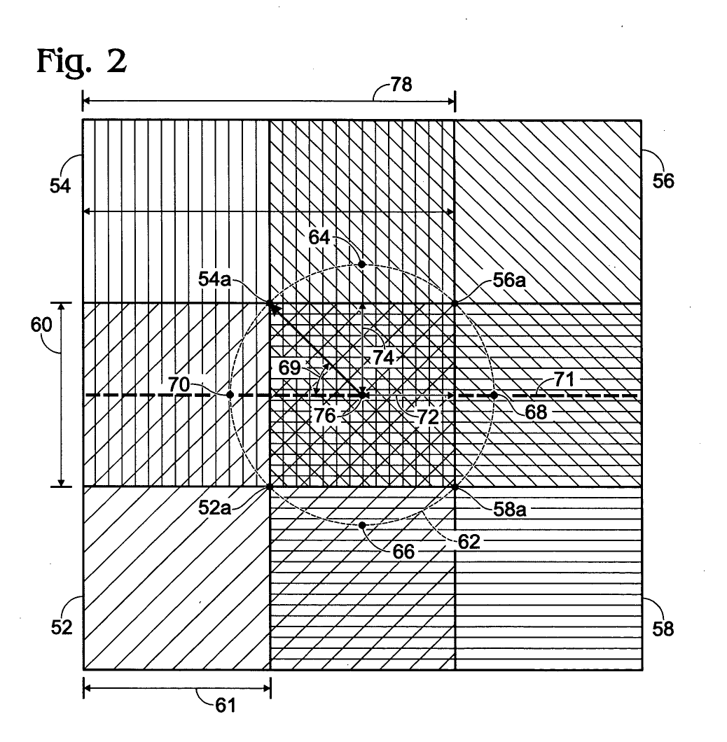

Angle of tilt 34 (theta 1) of surface 16 and angle 50 (theta 2) of rotation of image shifter 18 may be chosen so that the distance of deflection 42 (D) of output image 38 is sufficient to provide an increased resolution of a final image displayed on image plane 40, when compared to input image 14, as will be described with respect to FIG. 2.

Display system 10 may also include a projection lens 39 (shown in dash lines in FIG. 1) mounted within a path of output image 38. The optional projection lens 39 is only shown in FIG. 1 for ease of illustration. In an embodiment with no projection lens, K of Equation 1 will be equal to 1.0. In embodiments where a projection lens 39 is included, constant K may have a different value, depending on the individual projection lens or lenses utilized.

FIG. 2 represents a schematic front view of a pixel of the image shifting surface in several different positions. A pixel is shown in a first position 52, a second position 54, a third position 56 and a fourth position 58. The pixel at first position 52 has bottom left to top right diagonal stripes, is centered at 52a, is square, and has sides with length as shown 78 in the figure. Second position 54 is positioned one half pixel width 60 vertically above first position 52 and is illustrated with vertical stripes. Third position 56 is positioned one half pixel width 61 horizontally to the right of second position 54 and is illustrated with top left to bottom right diagonal stripes. Fourth position 58 is positioned one half pixel width 60 vertically below third position 56 and one half pixel width 61 horizontally to the right of first position 52 and is illustrated with horizontal stripes. Each of the pixel positions 52-58 define a center of the pixel, 52a-58a, respectively, wherein each of the centers 52a-58a of the pixel positions are located on a circular locus 62 of pixel positions as image shifter 18 is rotated about rotational axis 32 (see FIG. 1). Each of the pixel positions 52-58 and the pixel centers 52a-58a are slightly offset from one another due to image shifter surface 16 being positioned at angle 34 (see FIG. 1) with respect to plane 36 perpendicular to rotational axis 32.

Still referring to FIG. 2, the maximum vertical deflection of the pixels occurs at a highest point 64 and at a lowest point 66 on locus 62. These two positions, 64 and 66, show a pixel deflection of 0.354 pixels. Similarly, the maximum horizontal deflection of the pixels occurs at a right most point 68 and a left most point 70 on locus 62. These two positions, 68 and 70, also show a pixel deflection of 0.354 pixels, i.e., a length of the radius of locus 62. However, the four center positions 52a-58a of the pixel discussed above are not measured at the maximum vertical or maximum horizontal deflection points but instead are each positioned at an angle 69 of 45 degrees, 135 degrees, 225 degrees, and 315 degrees, respectively, as measured from the horizontal 71 such that at these four measured positions, the pixels are each displaced 0.250 pixels a horizontal distance 72 and a vertical distance 74. In other words, at angles 45 degrees, 135 degrees, 225 degrees, and 315 degrees, pixels 52-58 are each deflected one quarter of a pixel, i.e., 0.250 pixels, horizontally 72 and vertically 74 from an undeflected or center position 76. This one quarter vertical and horizontal deflection of the four pixel positions results in the one half pixel overlap of the four positions 52-58 shown in FIG. 2.

Accordingly, in Equation 1 listed above, distance of deflection 42 (D) can be set to 0.354 to determine a desired angle 34 of image shifting surface 16, which will yield four pixel positions 52-58, each which are offset one half pixel width 60, 61 from one another. As stated earlier, the four pixel positions 52-58 are achieved by rotating image shifting surface 16 about rotational axis 32 with image shifting surface 16 inclined at angle 34 with respect to plane 36 that is perpendicular to rotational axis 32. The four pixel positions 52-58 shown in FIG. 2 may result in a four-fold increase in resolution of output image 38 compared to input image 14 (see FIG. 1).

Angle 34 of image shifting surface 16 may be set at any desired angle to achieve a pixel shift a distance other than one half a pixel width, as may be desired for a particular application. For example, it may be desired to provide a plurality of pixel positions wherein each pixel is shifted a total of one third a pixel width with respect to one another.

The actual width of the pixels of the system may also be chosen as suited for a particular application. For example, a width 78 of a pixel 52 may be 50 microns such that half a pixel width 60, and a desired pixel deflection distance 42 may be 25 microns. In another embodiment, a width 78 of a pixel 52 may be one half inch, and a desired pixel deflection distance 42 may be one quarter inch. Accordingly, angle 34 may be any angle calculated to achieve the desired deflection distance 42 of the pixels, and may be as small as one thousandth of a degree, or several degrees, for example. In such cases where angle 34 is less than several degrees, distance 48 measured between image plane 40 and plane 36 may be substantially the same as the distance between image plane 40 and image shifting surface 16 for purposes of Equation 1.

Referring again to FIG. 1, image shifting surface 16 is shown rotated at an angle 50 of zero degrees about rotational axis 32, i.e., image shifting surface 16 is at a start position. In the embodiment shown, this position corresponds to maximum vertical displacement 64 in FIG. 2.

FIG. 3 shows image shifting surface 16 rotated at angle 50 of 180 degrees about rotational axis 32 from the position shown in FIG. 1. This position corresponds to the lowest position of vertical displacement 66 in FIG. 2.

In another embodiment, the image shifter 18 is held about the perimeter inside a large bearing which allows the optical axis of input image 14 to be coincident with the axis of rotation of image shifter 18 such that the projected image passes through the center of a rotating skewed transparent disk. This arrangement may reduce distortion of the final image. In another embodiment, the system may include a time varying distortion correaction that is applied to the image to compensate for artifacts introduced by the shifting system.

FIG. 4 represents a schematic view of a display system 80 according to another embodiment of the present invention and including a transmissive image shifter 18 including a transmissive image shifting surface 16. In this embodiment, image shifting surface 16 may be defined as the surface where output image 38 exits image shifter 18 or as the surface that is closest to image plane 40. In this embodiment, light source 20 may be positioned opposite image shifter 18 from image plane 40, i.e., behind image shifter 18 with respect to image plane 40. In such an embodiment, light image 14 may be projected toward image shifter 18 along a light path 84 parallel to rotational axis 32 and perpendicular to plane 36. In this figure image shifting surface 16 is rotated at an angle 50 of zero degrees about rotational axis 32, i.e., image shifting surface 16 is at a start position. This position corresponds to maximum vertical displacement 64 in FIG. 2. In this transmissive image shifting system 80, distance of deflection 42 of output image 38 may be defined by the refractive properties of the transmissive image shifter, rather than reflective properties. In this embodiment, front surface 16 is parallel to back surface 18a of image shifter 18 such that the thickness of image shifter 18 is substantially constant along its height. Accordingly, in FIGS. 4 and 5, back surface 18a of image shifter 18 is fixedly mounted in a tilted position on rotational shaft 28 with respect to plane 36 which is perpendicular to axis 32. In contrast, the image shifter 18 shown in FIGS. 1 and 3 includes a front surface 16 that is not parallel to back surface 18a and back surface 18a is mounted perpendicular to shaft 28 and is parallel to perpendicular plane 36.

FIG. 5 represents a schematic view of the display system of FIG. 4 wherein image shifting surface 16 is rotated 180 degrees from the position shown in FIG. 4. This position corresponds to maximum vertical displacement 66 in FIG. 2.

The foregoing description of embodiments of the invention have been presented for purposes of illustration and description. It is not intended to be exhaustive or to limit the invention to the precise form disclosed, and modifications and variation are possible in light of the above teachings or may be acquired from practice of the invention. The embodiments were chosen and described in order to explain the principles of the invention and its practical application to enable one skilled in the art to utilize the invention in various embodiments and with various modification as are suited to the particular use contemplated. It is intended that the scope of the invention be defined by the claims appended hereto and their equivalents.

We claim:

1. A display system, comprising:
a rotational actuator that defines a rotational axis;
an image shifter mounted on said rotational actuator for rotation about said rotational axis, said image shifter including an image shifting surface positioned non-perpendicular to said rotational axis; and
a light modulator that projects a modulated image to said image shifting surface.

2. The system of claim 1 wherein said rotational actuator includes a shaft that defines said rotational axis, and wherein said image shifter is mounted on said shaft.

3. The system of claim 1 wherein said image shifter is chosen from one of a reflective image shifter and a transmissive image shifter.

4. The system of claim 1 wherein said image shifting surface is positioned at an angle theta 1 with respect to a plane positioned perpendicular to said rotational axis, wherein an amount of deflection (D) of a light image by said image shifter is described by the equation D=2(theta 1)LK cos(theta 2) wherein L is a distance to an image plane from said image shifting surface, K is equal to 1.0 when there is no projection lens, and theta 2 is equal to an angle of rotation of said image shifting surface about said rotational axis.

5. The system of claim 1 further comprising a light source that projects light to said image shifter at an angle in a range of five to eighty-five degrees from said rotational axis.

6. The system of claim 1 wherein said image shifter is chosen from one of a reflective mirror and a transmissive glass member.

7. The system of claim 1 wherein rotational movement of said rotational actuator rotates said image shifting surface so as to shift a first image through at least four different positions to produce a second image having a resolution at least four times greater than a resolution of said first image.

8. The system of claim 1 wherein said rotational actuator rotates in one of a constant velocity profile and an incremental step velocity profile during use of said system.

9. The system of claim 2 wherein said shaft is rigid.

10. The system of claim 1 wherein said image shifter is mounted only to said rotational actuator.

11. The system of claim 1 wherein said rotational actuator is chosen from one of a dc motor and a stepper motor.

12. The system of claim 7 wherein said four different positions of said first image are each shifted with respect to one another a distance substantially equal to one half of a width of one pixel of said image.

13. A method of making a display system, comprising mounting an optical image shifter on a single rotating shaft such that an image shifting surface of said optical image shifter is positioned non-perpendicular to a rotational axis of said rotating shaft and is positioned to receive a modulated image from an image modulator.

14. The method of claim 13 further comprising positioning a light source with respect to said optical image shifter such that light emitted from said light source is shifted by said image shifter and forwarded to an imaging region.

15. The method of claim 14 wherein said optical image shifter is positioned at an angle theta with respect to a plane perpendicular to said rotational axis, and wherein said light shifted by said image shifter is displaced by an amount substantially equal to two times theta.

16. A method of using a display system, comprising:
rotating a shaft of a single actuator having an optical image shifter mounted on said shaft, wherein an image shifting surface of said optical image shifter is positioned non-perpendicular to a rotational axis of said shaft;
projecting a modulated light image to said image shifting surface from a light modulator; and
projecting a shifted light image from said image shifting surface.

17. The method of claim 16 wherein said shifted light image has a resolution higher than said modulated light image.

18. The method of claim 16 wherein said rotating a shaft comprises rotating in a manner chosen from one of rotating said shaft continuously and rotating said shaft between a plurality of dwell positions.

19. The method of claim 16 wherein said image shifting surface defines a plurality of pixels, and wherein each of said plurality of pixels is moved through a circular path around said rotational axis as said image shifting surface is rotated.

20. The method of claim 16 wherein said projecting a shifted light image is chosen from one of transmitting said light image and reflecting said light image.
